(19) United States
(12) Patent Application Publication
(10) Pub. No.: US 2012/0294563 A1
(43) Pub. Date: Nov. 22, 2012

(54) ELECTRO-OPTIC SILICON MODULATOR

(75) Inventors: David Thomson, Ash Vale (GB); Frederic Gardes, Guildford (GB); Graham Reed, Godalming (GB)

(73) Assignee: Southampton University

(21) Appl. No.: 13/476,279

(22) Filed: May 21, 2012

(30) Foreign Application Priority Data
May 20, 2011 (GB) 1108481.1

(51) Int. Cl. G02F 1/035

(52) U.S. Cl. 385/2

(57) ABSTRACT

The present invention provides an electro-optic modulator and an optical communication system in which a wider signal electrode may be used without affecting the characteristic impedance of the device or the efficiency of the optical modulation. In embodiments of the invention, asymmetric coplanar electrodes are provided such that the gap between the signal electrode and one reference electrode may be optimized for the optical waveguide and the semiconductor section surrounding it, and the gap between the signal electrode and the other reference electrode may be optimized for a particular characteristic impedance.

### CROSS REFERENCE TO RELATED APPLICATIONS

This application claims priority to the patent application of Great Britain No. GB 1108481.1 “Electrodes for high speed modulators” filed on May 20, 2011.

### FIELD OF THE INVENTION

The present invention relates to the field of electro-optical modulation, and particularly to electro-optic modulators with novel electrodes and modern high data rate optical communication systems comprising the same.

### BACKGROUND ART

Silicon microphotonics has generated an increasing interest in recent years. Integrating optics and electronics on the same chip would allow enhancement of integrated circuit (IC) performance. Furthermore, telecommunications could benefit from the development of low cost solutions for high-speed optical links. The realization of active photonic devices, in particular high speed optical modulators integrated in silicon-on-insulator (SOI) waveguides, is essential for the development of silicon microphotonics/nanophotonics.

Although silicon does not in normal circumstances exhibit a linear electro-optic (Pockels) effect, other mechanisms are available for modulation, including thermo-optic and plasma dispersion effects. Aside from these, further interesting methods have been reported which include using strain to introduce a Pockels effect, forming SiGe/Ge quantum wells to take advantage of the quantum-confined stark effect, and bonding III-V materials to make use of their stronger electro-optic properties. The disadvantage of these approaches is the complex or non-CMOS compatible fabrication processes involved. The thermo-optic effect in silicon is relatively, very slow and therefore has no real use for high speed applications. The plasma dispersion effect on the other hand is much more promising with most of the recent successful high-speed silicon modulators being based upon this effect, whilst using carrier injection, depletion or accumulation to cause the required changes in free-carrier concentration.

The plasma dispersion effect uses changes in the free-carrier concentration to cause modulation of the light passing through the device. The free-carrier concentration may be changed by injecting carriers into the device, depleting carriers from a region of the device or by causing an accumulation of charge carriers in a region of the device. Carrier injection is typically carried out in a PIN diode structure with the optical waveguide passing though the intrinsic region. When the diode is forward biased, carriers pass into the intrinsic region causing a change in refractive index. Carrier depletion can be based upon a PN junction diode in the waveguide. Reverse biasing the diode causes carriers to be swept out of part or all of the waveguide region, again resulting in a change in refractive index. Carrier accumulation involves the use of an insulating layer between P and N diode regions that will, when biased, cause an accumulation of free carriers on the edges of the layer, much like a capacitor. Carrier depletion and accumulation, unlike carrier injection, are not limited by the relatively long minority carrier lifetime in silicon and consequently the fastest reported devices have utilised these mechanisms.

Electrodes with high performance are required to drive the electrical input signal along the length of the optical modulator. The performance of the electrodes can dictate to some extent the overall performance of the optical modulator and therefore careful consideration of their design is required. Optical modulators can range in length from hundreds of micrometres to several millimetres and even centimetres.

There are three main considerations when designing the electrodes of an optical modulator.

1. The loss of the electrode (i.e. the attenuation of the electrical signal along the length of the modulator) should not be too high, and dependence of the loss on the frequency of the electrical signal should also be limited.

2. The electrode (including the effect of the optical modulator) should have characteristic impedance matched to that of the driving system and termination.

3. The velocity of the electrical signal along the electrode should match the velocity of the light propagating through the modulator.

The first consideration is important in ensuring both efficient use of the drive signal and a high modulation bandwidth. If the drive signal attenuates as it passes along the electrode then the phase shift produced will be less than if the full voltage is applied along the entire length of the device. Furthermore, frequency-dependent loss means that higher frequency components of the drive signal will be attenuated at a faster rate than low frequency components. This can limit the bandwidth since the modulation depth achieved at low frequencies will be larger than at high frequencies.

The second consideration relates to the fact that maximum transfer of the drive signal to the electrode is achieved when the characteristic impedances of the driving system and the electrode match at the boundaries between those two components. Similarly, by matching the characteristic impedances of the electrode and the terminating components, resonances in the system as a result of reflected signals can be reduced, which could otherwise degrade the performance of the device.

The final consideration is important as it can again set a modulation bandwidth limitation. If there is a mismatch between the velocities of the electrical signal and the light propagating in the waveguide, the modulation may be smeared over a longer period of the light. As the frequency of the drive signal is increased the edges of each bit, which become broadened due to the modulation smearing, start to overlap and interfere with each other.

In terms of the semiconductor part of the device (which also makes up the waveguide), the electrical contacts to the device should be as close to each other as possible in order to have a high modulation bandwidth. On the other hand, if the contacts are too close to the waveguide such that they interact with the propagating light, undesirable optical loss can be caused. There is therefore an optimum separation of the two electrical contacts set by the semiconductor element and this dimension should be taken into account when designing the layout of the electrodes.

Coplanar waveguide electrodes are typically used to bias the waveguide as they do not require a ground plane on the back-side of the substrate. One coplanar waveguide structure 10 is shown in plan view in FIG. 1 (prior art). Only the electrodes are illustrated for clarity. A signal electrode (also known as a signal track) 12 is surrounded on either side by two ground planes 14, 16. The semiconductor section of the device (comprising the optical waveguide) is not illustrated, but runs parallel to and between the signal track and one of the ground planes. The signal running down the signal track 12 provides a biasing potential which affects the dispersion characteristics of the waveguide.

It will be appreciated that the above problems are peculiar to modulators formed of silicon which, as described above, does not exhibit a strong or linear electro-optic effect so other mechanisms (such as the plasma dispersion effect) are used to effect modulation.

A wide signal track results in lower electrode loss (and lower frequency-dependent loss). However, in order to maintain impedance matching with the drive circuitry, the gap width between the signal track and the surrounding ground planes should be increased correspondingly. This is because the characteristic impedance of the coplanar waveguide electrode is dependent on the ratio of the signal track width and the gap widths.

This leaves three choices:

1. Increase the signal track and gaps correspondingly, so the impedance remains the same. However, this has a detrimental effect on the bandwidth of the semiconductor section as the gap between the contacts is increased.

2. Use a relatively thin signal track but choose an optimal gap width for the semiconductor section. This has a detrimental effect on the bandwidth of the electrode.

3. Increase the signal track width without increasing the gaps between the signal track and the ground planes. However, in this case the characteristic impedance of the modulator will no longer match that of the drive circuitry and termination components, resulting in reflections of the drive signal.

None of these solutions is ideal. And there is a need for find an optimal solution to overcome the existing problems.

### SUMMARY OF THE INVENTION

The present invention addresses the use of an asymmetric coplanar waveguide in optical modulators, having non-equal gap widths on either side of the signal track. This allows for a wide signal track with optimal gap on one side (in terms of the performance of the semiconductor section) and a gap on the other side used to tune the impedance of the device as required.

In one aspect, the present invention provides an electro-optic modulator comprising: an optical waveguide integrated in a layer of silicon; and biasing circuitry for applying an electric potential across the waveguide. The biasing circuitry comprises a signal electrode coupled to one side of the waveguide, for application of an electrical signal; a primary reference electrode coupled to the other side of the waveguide, for application of a reference signal; and a secondary reference electrode, also for application of said reference signal, located such that the signal electrode lies in a coplanar arrangement between the reference electrode and the secondary reference electrode. A first gap between the signal electrode and the primary reference electrode and a second gap between the signal electrode and the secondary reference electrode are not equal.

By permitting an asymmetric electrode system, embodiments of the present invention allow the first gap to be tuned or optimized for the optical waveguide, while the second gap can be tuned or optimized to set the characteristic impedance of the modulator. This in turn allows a wider signal electrode to be used, increasing the bandwidth of the modulator.

In an embodiment of the present invention therefore, the first gap has a minimized width such that the signal electrode and/or the primary reference electrode does not interact with light propagating in the waveguide. In a further embodiment, the second gap has a width such that a characteristic impedance of the biasing circuitry takes a desired value.

The terms “gap” and “width” will be understood within the context of a signal electrode which is elongate and generally runs parallel to the primary and secondary reference electrodes, i.e. such that the gaps have substantially constant widths.

In an embodiment of the present invention, the signal electrode has a width in the range from 5 to 20 μm. In further embodiments, at least the signal electrode and the primary reference electrode have a thickness in the range from 1 to 5 μm.

Where the optical waveguide is formed in a first layer together with electronic components, it may not be possible to increase the electrode thickness to these values. In an embodiment, therefore, the biasing circuitry is located on a second, higher layer with greater thickness than said first layer, and contact down to the optical waveguide. The terms “first layer” and “second layer” as used herein are not intended to refer to any metal layer in particular, but rather to any two different metal layers.

According to a second aspect of the present invention, there is provided an optical communication system, comprising: an electro-optic modulator as set out above; a source of photons, coupled to the waveguide; and driving circuitry coupled to the biasing circuitry, for generating the electrical signal.

In an embodiment, the second gap is set to have a width such that a characteristic impedance of the biasing circuitry is equal to a characteristic impedance of the driving circuitry at a boundary between the two. In this way, reflections of the electrical signal are reduced or minimized.

In a yet further embodiment, the electrical signal alternates at a frequency f, resulting in a skin depth δ (according to the equation given below). In this case, at least the signal electrode and the primary reference electrode have a thickness in the range from 2δ to 5δ such that the AC current of the electrical signal is spread through the conductor as much as possible.

### BRIEF DESCRIPTION OF THE DRAWINGS

An embodiment of the present invention will now be described by way of example, with reference to the accompanying figures in which;

FIG. 1 (Prior Art) is a plan view of a conventional coplanar waveguide structure;

FIG. 2 shows an optical modulator according to embodiments of the present invention;

FIG. 3 shows a plan view of a coplanar waveguide structure according to embodiments of the present invention;

FIG. 4 is a graph illustrating the bandwidth of electrodes with different thicknesses; and

FIG. 5 shows an optical communication system according to embodiments of the present invention.

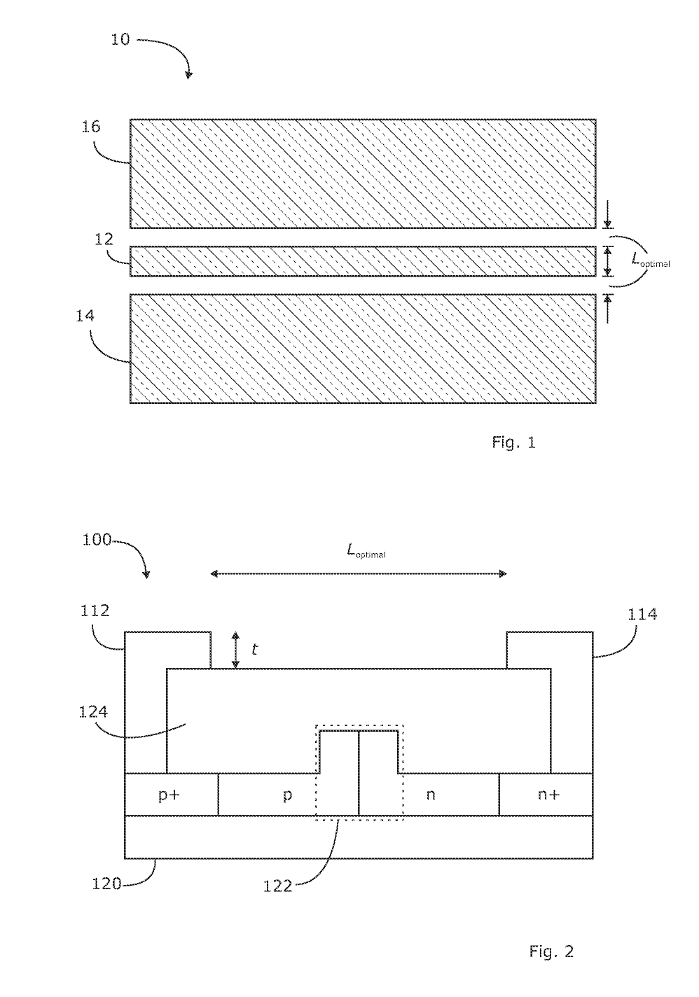

### DETAILED DESCRIPTION OF THE EMBODIMENTS

FIG. 2 shows in cross-section the optical part of a modulator 100 according to embodiments of the present invention. A layer of light-carrying material (silicon) is formed on an insulating substrate 120 (such as SiO₂). The insulating layer 120 is frequently referred to in the art as a ‘buried oxide’ layer. However, alternative materials will be apparent to those skilled in the art, such as (but not limited to) silicon on sapphire (where the entire sapphire substrate is insulating), germanium on silicon, and silicon-germanium on insulator.

The light-carrying material has a thicker portion known as the “rib” 122, which acts as a waveguide and along which photons propagate when the modulator 100 is in use. Insulating cladding (e.g. SiO₂) 124 is provided to protect the waveguide from damage and to reduce optical losses. The device 100 would also work with an air (or other) cladding, however (i.e. without the insulating layer 124). A signal electrode 112 and one reference electrode 114 are coupled to the light-carrying layer on either side of the waveguide 122, such that an electric potential between the two effectively biases the light-carrying material and the waveguide 122.

The light-carrying material is divided into differently doped regions such that a pn junction is formed somewhere between the two electrodes 112, 114. In the illustrated example the pn junction is formed in the waveguide 122; however, it may also be formed to the side of the waveguide. Regions of higher doping concentration are formed at the connections to the respective electrodes.

The p- and n-type regions are typically doped at a concentration of between about 10¹⁶ and 10¹⁸ cm⁻³; and the p+ and n+ regions doped at a concentration of between about 10¹⁸ and 10²⁰ cm⁻³, although different concentrations may be used, and the ranges may overlap. It will be appreciated that the terms n and n+ (and similarly p and p+) are used to denote differences in the carrier concentration rather than absolute concentrations. The absolute concentrations may be tailored as desired in order to achieve a certain performance characteristic. Examples of possible p-type dopants are boron, and possible n-type dopants include phosphorus, antimony and arsenic.

It has been explained above that there is an optimal distance between the electrodes 112, 114 which balances the requirement that the electrical signal in the electrodes not interfere with the photons in the waveguide 122, with the requirement for the electrodes to be as close to each other as possible. Effectively, it is the minimum distance at which the former requirement is satisfied. The length is hereinafter denoted Lₒₚₜᵢₘₐₗ, and it will be seen that the electrodes 112, 114 of the modulator 100 are separated by this distance. The electrodes 112, 114 also have a thickness t.

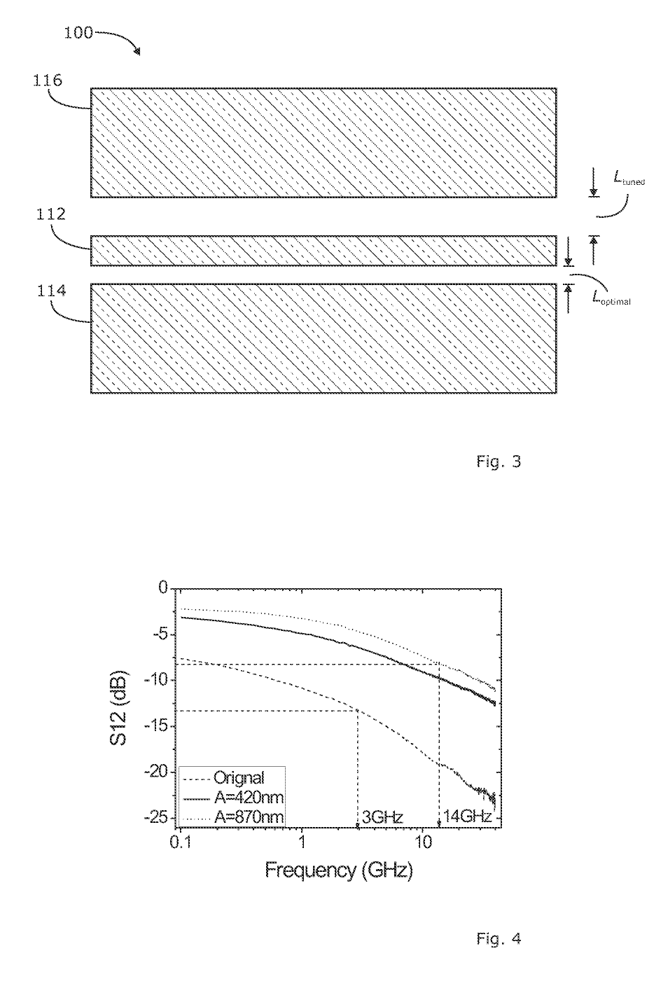

FIG. 3 shows in plan view biasing circuitry of the modulator 100 according to embodiments of the present invention. The biasing circuitry comprises the electrodes 112, 114, as well as a further reference electrode 116 which is referred to as a secondary reference electrode. The signal electrode 112 is connected to a system which generates a biasing electrical signal. The primary reference electrode 114 is connected to a reference signal, such as ground.

In general, the electrodes take the familiar coplanar arrangement. The optical part of the modulator runs between the signal electrode 112 and the primary reference electrode 114, separated by Lₒₚₜᵢₘₐₗ as described above. The secondary reference electrode 116, however, is separated from the signal electrode 112 by a gap L_{tuned}, which is different from Lₒₚₜᵢₘₐₗ. That is, the electrode arrangement is asymmetrical. In one embodiment, L_{tuned} is greater than Lₒₚₜᵢₘₐₗ.

As explained above, a wider signal electrode 112 provides a higher bandwidth in the electrical signal. However, increasing the width of the signal electrode has a knock-on effect on the characteristic impedance of the modulator (if the gap between signal and reference electrodes is not also increased) or the efficiency of the modulator (if the gap between signal and reference electrodes is increased). According to embodiments of the present invention, the gap between the signal electrode 112 and the primary reference electrode 114 (i.e. those electrodes coupled to the waveguide 122) is kept at Lₒₚₜᵢₘₐₗ. This provides optimal performance in the waveguide itself and the surrounding semiconductor section. The gap between the signal electrode 112 and the secondary reference electrode 116 is changed to a different value L_{tuned}, such that the characteristic impedance of the modulator 100 is kept at the same value. This allows the signal electrode to have a greater width (and therefore a greater bandwidth) and yet keep the same characteristic impedance by appropriate adjustment of L_{tuned}. In one embodiment, the signal electrode 112 has a width in the range from 5 to 20 μm.

In a further aspect of the present invention, the inventors have found that the bandwidth of the modulator 100 can be increased by increasing the thickness t of the electrodes 112, 114. For example, FIG. 4 shows a graph illustrating the bandwidth of electrodes with different thicknesses. The results were taken by an s-parameter measurement tool which measures the magnitude of the electrical signal at the end of the electrode. The different lines represent different metal thicknesses. The original electrodes (dashed line) are 480 nm thick, and the parameter A represents the additional thickness of the electrodes over the original. The solid line is therefore the result for a 900 nm thick electrode and the dotted line for a 1350 nm thick electrode.

If the bandwidth of the electrode is lower than the frequency limitation of the semiconductor section (i.e. the waveguide 122) and any frequency limitation placed upon the device 100 by an electrical signal-light velocity mismatch, then it will be the limiting factor in the high speed performance of the device. With the original electrodes (of thickness 480 nm) the device would be limited to 3 GHz operation even if the semiconductor section is able to go much faster.

The skin depth is an important consideration when selecting an appropriate metal thickness for the electrodes. AC signals propagate along a conductor close to the surface (or skin) and the skin depth defines the distance into the conductor from the surface where the current density has fallen by a factor 1/e. The skin depth δ is dependent on the frequency of operation f, the resistivity of the conductor ρ and the absolute permeability of the conductor μ according to the following expression:

$$δ = \sqrt{\frac{ρ}{f πμ}}$$

In order for the resistance of the AC signal (and therefore attenuation) to be as small as possible in one embodiment the electrode thickness is selected such that the AC current is spread through the conductor as much as possible. Therefore typically 2 to 5 skin depths should be used at the frequency of operation. Aluminium is typically used in the backend of standard CMOS processes and the skin depth of aluminium at 10 GHz is approximately 850 nm. In one embodiment, therefore, an electrode thickness of 1.7 to 4.3 μm (or 1 to 5 μm) is used for operation at 10 GHz. For combined front end photonic-electronic integration schemes where photonic and electronic components are fabricated side by side on the same substrate and therefore share the same backend, this can be problematic since the first metal layer can be as thin as 500 nm. In this case, where there is no flexibility in the metal thickness, it is desirable to form the electrodes on higher metal layers which have greater thickness and to contact down to the semiconductor layer.

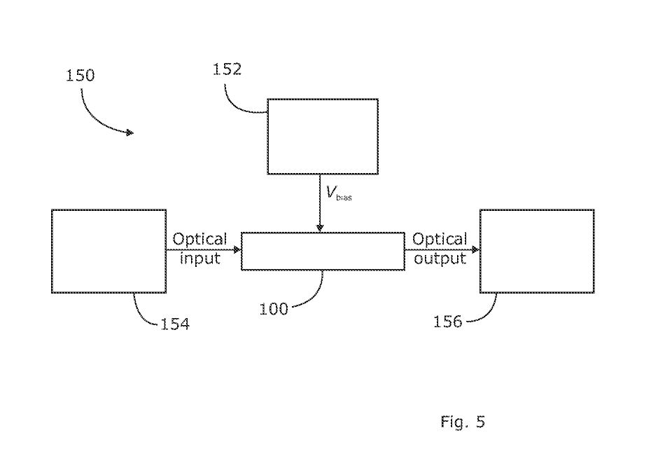

FIG. 5 shows an optical communication system 150 according to embodiments of the present invention. A driving system 152 provides a biasing electrical signal V_{bias} to the signal electrode 112; reference electrodes 114, 116 are connected to a reference signal input, e.g. ground. The driving system 152 has an impedance of typically 50 Ohms. The value of L_{tuned} is therefore chosen such that the characteristic impedance of the modulator 100 is equal to that of the driving system 152.

An optical input to the waveguide 122 is provided by a source of photons 154. The modulated optical signal is output to further components of the system, illustrated generally by the reference numeral 156.

It was shown by the inventors of the present application that implementation of silicon optical modulators in optical communications system allows achieving transmission rates up to 50 Gb/s, see, for example “High contrast 40 Bgit/s optical modulation in silicon” by D. J. Thomson et al., Optics Express, v. 19, No. 12, p. 11507 (2011) and “50-Gb/s silicon optical modulator” by D. J. Thomson et al., IEEE Photonics Technology Letters, v. 24, No. 4, p. 234 (2012).

The present invention thus provides an electro-optic modulator and an optical communication system in which a wider signal electrode may be used without affecting the characteristic impedance of the device or the efficiency of the optical modulation. In embodiments of the invention, asymmetric coplanar electrodes are provided such that the gap between the signal electrode and one reference electrode may be optimized for the optical waveguide and the semiconductor section surrounding it, and the gap between the signal electrode and the other reference electrode may be optimized for a particular characteristic impedance.

It will of course be understood that many variations may be made to the above-described embodiment without departing from the scope of the present invention. In particular it will be understood that the present invention is not limited to the illustrated arrangements of doped regions. For example, the reverse arrangements are also possible, in which p-type and p+ type regions are replaced with n-type and n+ type regions and vice versa. Various positions and shapes of the junction between the n-type and p-type regions are also possible. Furthermore, it will be understood by those skilled in the art that the modulator design set out in FIG. 2 is illustrative of one possible design which may be used with the electrode design described above and with respect to FIG. 3 in particular. The electrodes could also be applied to other modulators based upon other effects, such as carrier accumulation and injection, as well as modulators formed in other photonic materials.

1. An electro-optic modulator comprising:
an optical waveguide integrated in a layer of silicon; and
a biasing circuitry for applying an electric potential across the waveguide, said biasing circuitry comprising:
a signal electrode coupled to one side of the waveguide, for application of an electrical signal;
a primary reference electrode coupled to the other side of the waveguide, for application of a reference signal; and
a secondary reference electrode, for application of said reference signal, located such that the signal electrode lies in a coplanar arrangement between the primary reference electrode and the secondary reference electrode,
wherein a first width of a first gap between the signal electrode and the primary reference electrode and a second width of a second gap between the signal electrode and the secondary reference electrode are not equal.

2. The electro-optic modulator according to claim 1, wherein the first width is such that the signal electrode and/or the primary reference electrode does not interact with a light propagating in the waveguide.

3. The electro-optic modulator according to claim 2, wherein the second width is such that a characteristic impedance of the biasing circuitry takes a desired value to achieve an improved modulator performance compared to a performance of a modulator with equal the first and the second gap widths.

4. The electro-optic modulator according to claim 1, wherein the second width is such that a characteristic impedance of the biasing circuitry takes a desired value to achieve an improved modulator performance.

5. The electro-optic modulator according to claim 4, wherein the improved performance is an increased modulation bandwidth.

6. The electro-optic modulator according to claim 1, wherein the signal electrode is elongate and runs parallel to the primary and secondary reference electrodes.

7. The electro-optic modulator according to claim 1, wherein the signal electrode has a width in the range from 5 to 20 μm.

8. The electro-optic modulator according to claim 1, wherein at least the signal electrode and the primary reference electrode have a thickness in the range from 1 to 5 μm.

9. The electro-optic modulator according to claim 1, wherein thicknesses of the electrodes may be different and is optimized for improved performance.

10. The electro-optic modulator according to claim 1, wherein the optical waveguide is formed in a first layer together with electronic components, and wherein the biasing circuitry is located on a second, higher layer with greater thickness than said first layer.

11. The electro-optic modulator according to claim 1 which is arranged such that modulation is effected by the plasma dispersion effect.

12. An optical communication system, comprising:
a source of photons, coupled to an optical waveguide of
an electro-optic modulator, the modulator comprising
the optical waveguide integrated in a layer of silicon; and
a biasing circuitry for applying an electric potential across the waveguide, the biasing circuitry is driven by electrical signals provided by a driving circuitry; and
said biasing circuitry comprising:
a signal electrode coupled to one side of the waveguide, for application of an electrical signal;
a primary reference electrode coupled to the other side of the waveguide, for application of a reference signal; and
a secondary reference electrode, for application of said reference signal, located such that the signal electrode lies in a coplanar arrangement between the primary reference electrode and the secondary reference electrode,
wherein a first width of a first gap between the signal electrode and the primary reference electrode and a second width of a second gap between the signal electrode and the secondary reference electrode are not equal.

13. The optical communication system according to claim 12, wherein the second gap has a width such that a characteristic impedance of the biasing circuitry is equal to a characteristic impedance of the driving circuitry at a boundary between the two.

14. The optical communication system according to claim 12, wherein the electrical signal alternates at a frequency f, resulting in a skin depth δ, and wherein at least the signal electrode and the primary reference electrode have a thickness in the range from 2δ to 5δ.

15. The optical communication system according to claim 12, wherein the optical waveguide is formed in a first layer together with electronic components, and wherein the biasing circuitry is located on a second, higher layer with greater thickness than said first layer.

16. An optical modulator for embedding data on an optical beam, comprising:
an optical waveguide integrated in a layer of silicon, and
an electrode system with at least three parallel electrodes applying an electric potential across the waveguide; the electrode system being asymmetric with a first gap between a first and a central electrode and a second gap between a second and the central electrode, wherein widths of the first and the second gaps are different; wherein
the first width is optimized for the optical waveguide to embed data; and
the second width is optimized to set the characteristic impedance of the modulator to achieve the improved performance.

17. The optical modulator of the claim 16, wherein the improved performance is in better modulation characteristics compared with a modulator having equal the first and the second gap widths.

18. The optical modulator of the claim 16, wherein a thickness of the electrodes is selected to allow an AC current to spread through a conductor to improve the modulator performance.

19. The optical modulator of the claim 16, wherein the modulator operates in a long haul optical communication system with high data rates up to 50 Gb/s.

20. The optical modulator of the claim 15, wherein the modulator operates in a radio-over-fiber links.
